(19) United States
(12) Patent Application Publication
(10) Pub. No.: US 2013/0024212 A1
(43) Pub. Date: Jan. 24, 2013

(54) METHOD AND SYSTEM FOR OPTIMIZING QUESTIONNAIRES

(71) Applicants: Maryam Atakhorrami, Cambridge (GB); Amy Oi Mee Cheing, Eindhoven (NL)

(72) Inventors: Maryam Atakhorrami, Cambridge (GB); Amy Oi Mee Cheing, Eindhoven (NL)

(73) Assignee: KONINKLIJKE PHILIPS ELECTRONICS N.V., EINDHOVEN (NL)

(21) Appl. No.: 13/638,005

(22) PCT Filed: Feb. 24, 2011
(86) PCT No.: PCT/IB2011/050791

§ 371 Date: Sep. 28, 2012

Related U.S. Application Data
(60) Provisional application No. 61/319,403, filed on Mar. 31, 2010.

(51) Int. Cl. G06Q 50/24

(52) U.S. Cl. 705/3

(57) ABSTRACT

A computer-implemented method for providing a questionnaire to a patient based on patient's current health condition is provided. The method includes measuring physical activity of the patient with an activity monitor; measuring respiration rate with a respiration rate sensor; measuring heart rate with a heart rate monitor; measuring cough frequency with a cough frequency monitor; and executing, on the processor of the computer system, one or more computer program modules configured to generate a questionnaire to gather information from the patient. The questionnaire comprises a set of questions that are based the gathered physical activity data, respiration rate data, heart rate data, cough frequency data, or any combination thereof.

This patent application claims the priority benefit under 35 U.S.C. §119(e) of U.S. Provisional Application No. 61/319,403 filed on Mar. 31, 2010, the contents of which are herein incorporated by reference.

The present invention relates to a method and a system for providing a questionnaire to a patient based on patient's current health condition.

Questionnaires are used to assess certain aspects/symptoms, e.g., dyspnea (i.e., shortness of breath or breathlessness), depression, or any specific physical activities performed, of a disease that may not be objectively evaluated using sensor(s).

Also, questionnaires are used for qualitatively assessing the symptoms and the quality of life of patients suffering from chronic diseases, e.g., Heart Failure (HF), Chronic Obstructive Pulmonary Disease (COPD), or Diabetes. COPD is a respiratory disease that is characterized by inflammation of the airways with extra pulmonary effect (such as diabetes, heart failure, muscle wasting, depression, etc.) affecting health related quality of life. COPD is characterized by an airflow limitation that is typically not fully reversible. The airflow limitation is both progressive and associated with an abnormal inflammatory response of the lungs to noxious particles or gases. Symptoms of COPD may include coughing, dyspnea, i.e., shortness of breath or breathlessness, wheezing and the production of mucus and the degree of severity may, in part, be viewed in terms of the volume and color of secretions.

Questionnaires are generally available in different forms. For example, questionnaires may include questions with multiple choice responses, questions with yes/no (or true/false) responses and/or questions with a scaled/graded responses that allows a user to indicate their perception of a particular aspect/symptom of the disease.

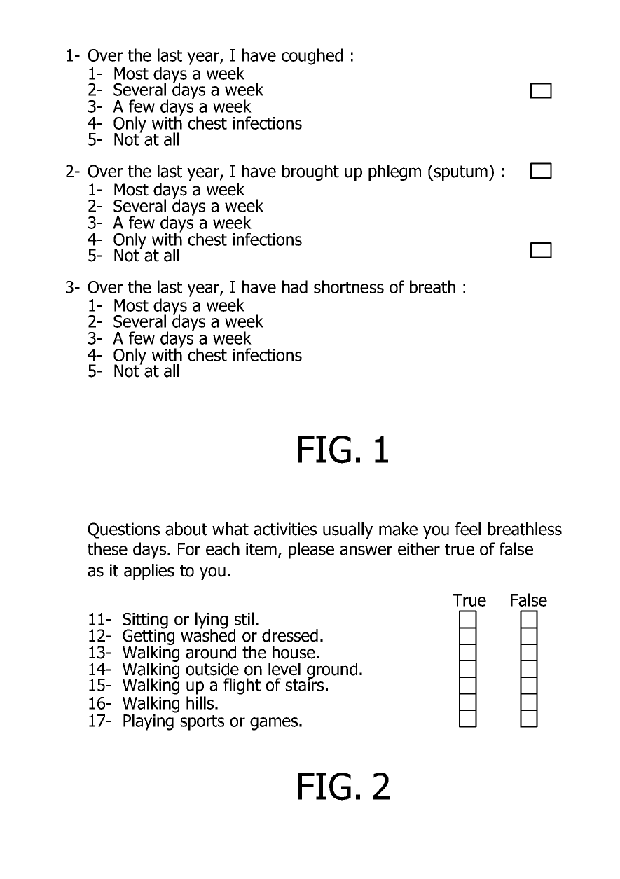

For example, St Georges Respiratory Questionnaire (SGRQ) is a fifty question survey that is administered to assess the overall health status of a COPD patient. The SGRQ generally includes both questions with multiple choice answers, and questions with yes/no (or true/false) answers. FIG. 1 shows questions with multiple choice answers in the SGRQ. FIG. 2 shows questions with yes/no (or true/false) answers in the SGRQ.

Dyspnea (i.e., shortness of breath or breathlessness) is one the most common symptom for COPD or HF patients. The worsening of dyspnea is an important indicator for the deterioration of health status of COPD or HF patient. Therefore, measurement of dyspnea provides valuable information for assessing the health status of COPD or HF patient.

Currently, dyspnea is measured using questionnaires. One such (most widely used) questionnaire is the Medical Research Council (MRC) questionnaire (See Table. 1). The MRC questionnaire, as shown in Table 1, is a five point scale questionnaire that allows patients to indicate the extent to which their breathlessness affects their daily activities. However, the MRC questionnaire does not quantify breathlessness itself and only provides a measure of perception of dyspnea by the patient. The perception of dyspnea is variable from patient to patient, as some patients may underestimate their level of dyspnea while other patients may overestimate their level of dyspnea.

TABLE 1
MRC questionnaire

| Scale | Severity |
|---|---|
| 1 | Breathless with strenuous exercise |
| 2 | Short of breath when hurrying on the level surface or |
| | walking up a slight hill |
| 3 | Walks slower than people of the same age on a level |
| | surface because of breathlessness of I have to stop |
| | or I have to stop for breath when walking at my own |
| | pace on the level surface |
| 4 | Stops for breath after walking for 100 meters or a few |
| | minutes on a level surface |
| 5 | Too breathless to leave the house or I am breathless |
| | dressing and undressing |

Questionnaires may generally be available in two forms: short questionnaires and long/extensive questionnaires. The short questionnaires, e.g., the MRC questionnaire, generally have very specific questions/statements and take, for example, approximately five minutes to complete, which is acceptable for patients. These short questionnaires are designed to ensure compliance, but are insensitive to detecting changes in symptoms. For example, the MRC questionnaire lacks sensitivity to detect changes in the level of dyspnea. Such short questionnaires are unable to provide an accurate assessment of symptom (e.g., dyspnea), as these questionnaires do not account for a modification in behavior of the patient (e.g., patient may walk less to avoid getting breathless) and variation in effort provided by the patient (e.g., slow walking vs. fast walking).

The long/extensive questionnaires (e.g., the SGRQ questionnaire) on the other hand are more sensitive to detecting changes in symptoms and provide a comprehensive assessment of the patient's health status. These long/extensive questionnaires, however, are time consuming (e.g., at least 15 minutes) to fill in, which is tiresome, for example, for many elderly patients. Furthermore, these long/extensive questionnaires cannot be used on a daily basis.

Accordingly, it is an object of the present invention to provide a questionnaire method that overcomes the shortcomings of conventional method. This object is achieved according to one embodiment of the present invention by providing a computer-implemented method for providing a questionnaire to a patient based on the patient's current health condition. The method includes measuring the physical activity of the patient with an activity monitor to gather physical activity data; measuring respiration rate of the patient with a respiration rate sensor to gather respiration rate data; measuring heart rate of the patient with a heart rate monitor to gather heart rate data; measuring cough frequency of the patient with a cough frequency monitor to gather cough frequency data; and executing, on the one or more processors of the computer system, one or more computer program modules configured to generate a questionnaire to gather information from the patient. The questionnaire includes a set of questions that are based on one or more of the physical activity data, the respiration rate data, the heart rate data and the cough frequency data.

Another aspect of the present invention provides a system for providing a questionnaire to a patient based on the patient's current health condition. The system includes at least one sensor, and at least one processor. The sensor is configured to measure a) physical activity of the patient to gather physical activity data; b) a respiration rate of the patient to gather respiration rate data; c) heart rate of the patient to gather heart rate data; and d) cough frequency of the patient to gather cough frequency data. The processor is operatively connected to the sensor and is configured to generate a questionnaire to gather information from the patient. The questionnaire includes a set of questions that are based on one or more of the physical activity data, the respiration rate data, the heart rate data, and the cough frequency data.

Another aspect of the present invention provides a system for providing a questionnaire to a patient based on patient's current health condition. The system includes means for measuring physical activity of the patient with an activity monitor to gather physical activity data; means for measuring respiration rate of the patient to gather respiration rate data; means for measuring heart rate of the patient to gather heart rate data; means for measuring cough frequency of the patient to gather cough frequency data; and means for executing, on one or more computer processors, one or more computer program modules to generate a questionnaire to gather information from the patient. The questionnaire includes a set of questions that are based on one or more of the physical activity data, the respiration rate data, the heart rate data and the cough frequency data.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. It shall also be appreciated that the features of one embodiment disclosed herein may be used in other embodiments disclosed herein.

FIG. 1 shows an exemplary questionnaire (i.e., St Georges Respiratory Questionnaire (SGRQ)) having questions with multiple choice answers;

FIG. 2 shows an exemplary questionnaire (i.e., St Georges Respiratory Questionnaire (SGRQ)) having questions with yes/no (or true/false) answers;

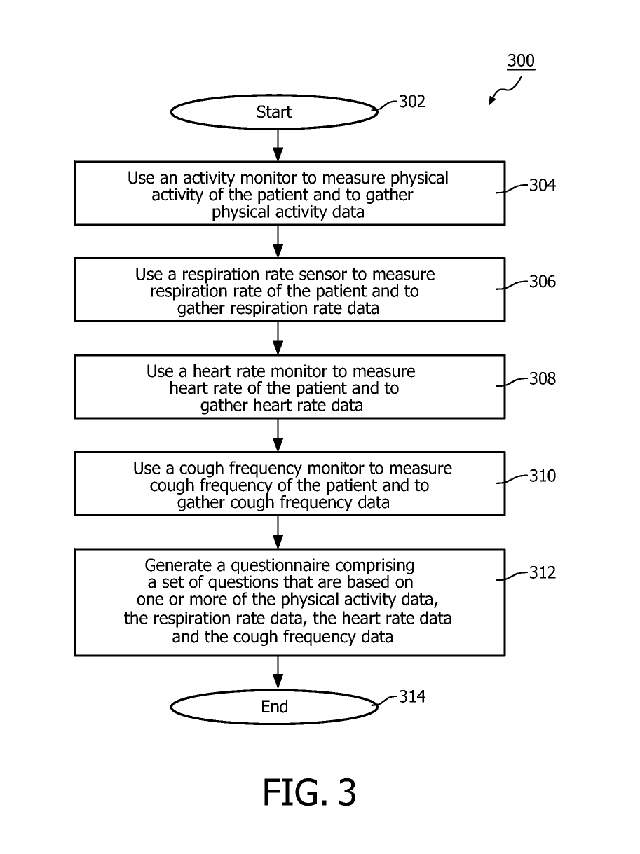

FIG. 3 shows a flow chart illustrating a method for providing a questionnaire to a patient based on patient's current health condition in accordance with an embodiment of the present invention;

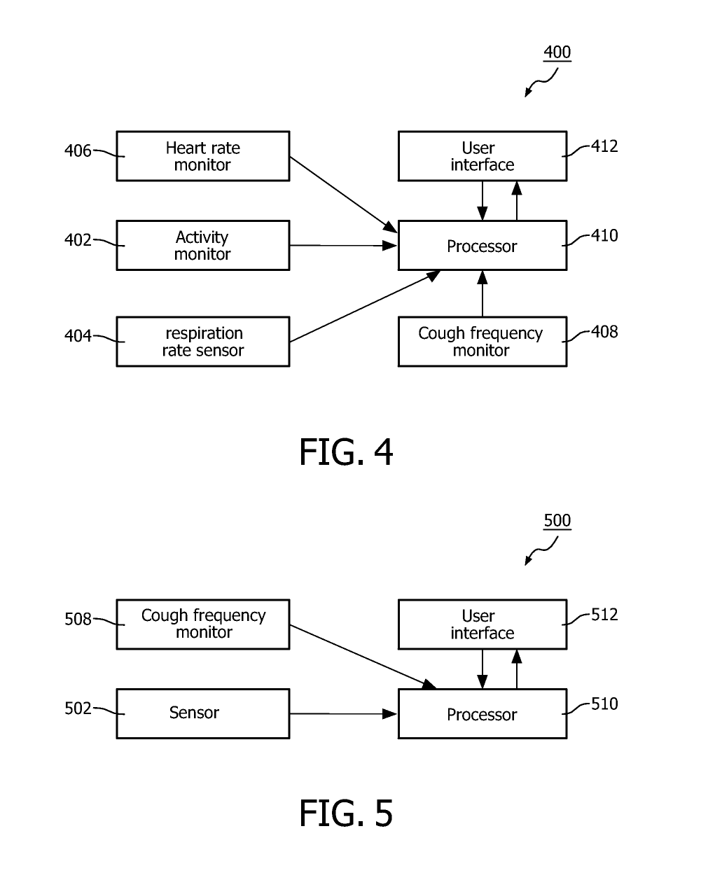

FIG. 4 shows a system for providing a questionnaire to a patient based on patient's current health condition in accordance with an embodiment of the present invention;

FIG. 5 shows a system for providing a questionnaire to a patient based on patient's current health condition in accordance with another embodiment of the present invention;

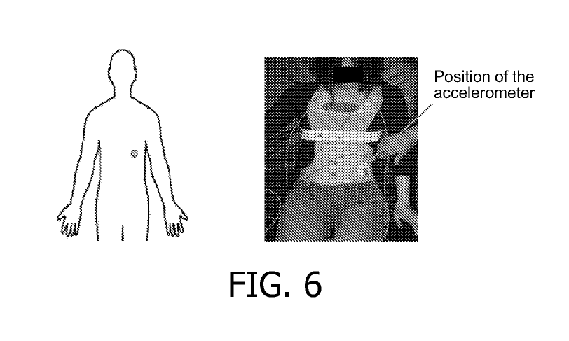

FIG. 6 shows the positioning of an accelerometer in accordance with an embodiment of the present invention; and

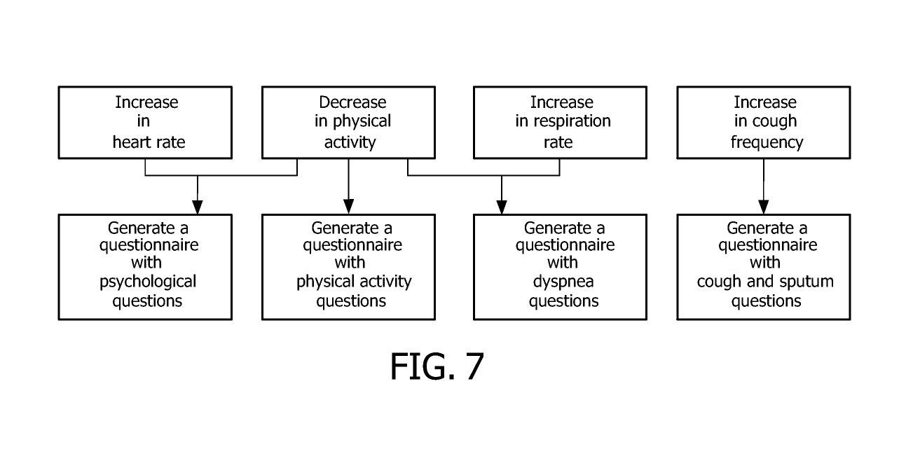

FIG. 7 shows an exemplary algorithm that is used by a processor of the system for selecting (i.e., based on patient's current health condition) a set of relevant questions that are being presented in the form of a questionnaire to the patient in accordance with an embodiment of the present invention.

FIG. 3 is a flow chart illustrating a computer implemented method 300 for providing a questionnaire to a patient based on patient's current health condition in accordance with an embodiment of the present invention. Method 300 is implemented in a computer system comprising one or more processors 410 (as shown in and explained with respect to FIG. 4) or 510 (as shown in and explained with respect to FIG. 5) configured to execute one or more computer programs modules. In one embodiment, processor 410 (as shown in and explained with respect to FIG. 4) or 510 (as shown in and explained with respect to FIG. 5), each can comprise either one or a plurality of processors therein.

In one embodiment, method 300 is configured to measure (i.e., using the set of sensor or sensors) various physiological parameters of the patient, such as physical activity, respiration rate, heart rate, and/or cough frequency, to provide an objective assessment of the patient health status/condition. Method 300 is then configured to select the most suitable set of questions (e.g., the top five most relevant questions) for patients based on their current health condition and to present these most relevant set of questions in the form a questionnaire for the patient to complete. Thus, this dynamic form of questionnaire generated by method 300 is configured to capture and present the questions that are most relevant to the patient.

The questionnaire generated by method 300 is also short because it presents most relevant questions to the patient (i.e., rather than presenting all the questions). This dynamic or smart selection of questions also allows for frequent quantitative and qualitative monitoring. Further, less time and effort is required by the patient to complete such a dynamic form of questionnaire.

Method 300 (and systems 400 and 500 described in detail below) is configured to use a combination of both objective measurement (i.e., obtained by monitoring the various physiological parameters) and questionnaires with specifically relevant questions to provide a complete evaluation of the patient. Method 300 (and systems 400 and 500 described in detail below) is configured to provide a dynamic assessment of the patient based on their current health condition.

The computer implemented method 300 begins at procedure 302. At procedure 304, a physical activity of the patient is measured to gather physical activity data. The physical activity of the patient is measured using an activity monitor, such as sensor 402 (as shown in and explained with respect to FIG. 4) or sensor 502 (as shown in and explained with respect to FIG. 5). In one embodiment, the physical activity is measured in arbitrary acceleration units (AAU).

At procedure 306, a respiration rate of the patient is measured to gather respiration rate data. The respiration rate of the patient is measured using a respiration rate sensor, such as sensor 404 (as shown in and explained with respect to FIG. 4) or sensor 502 (as shown in and explained with respect to FIG. 5). The respiration rate is generally representative of number of breaths taken by a patient per unit of time. In one embodiment, the respiration rate is expressed as breaths per minute.

At procedure 308, a heart rate of the patient is measured to gather heart rate data. The heart rate of the patient is measured using a heart rate monitor, such as sensor 406 (as shown in and explained with respect to FIG. 4) or sensor 502 (as shown in and explained with respect to FIG. 5). The heart rate is generally representative of number of heartbeats of the patient per unit of time. In one embodiment, the heart rate is expressed as beats per minute (BPM). In one embodiment, the heart rate of the patient may vary with a change in the amount of oxygen needed by the patient, for example, during exercise or rest (e.g., sleep).

At procedure 310, a cough frequency of the patient is measured to gather cough frequency data. The cough frequency of the patient is measured using a cough frequency monitor, such as sensor 408 (as shown in and explained with respect to FIG. 4) or the sensor 508 (as shown in and explained with respect to FIG. 5). The cough frequency is generally representative of number of coughs (or cough counts) of the patient per unit of time. In one embodiment, the cough frequency is expressed as cough counts per hour.

In one embodiment, as illustrated in FIG. 4, each of the physical activity, the respiration rate, and the heart rate of the patient may be measured using separate sensors. In another embodiment, as shown in FIG. 5, a single sensor, such as sensor 502, may be used measure the physical activity, the respiration rate, and/or the heart rate of the patient.

In one embodiment, as shown in and explained with respect to FIG. 4, the physical activity data of the patient from activity monitor 402, the respiration rate data of the patient from respiration rate sensor 404, the heart rate data of the patient from heart rate monitor 406, and the cough frequency data of the patient from cough frequency monitor 408 are received by one or more processors 410. In another embodiment, as shown in and explained with respect to FIG. 5, the physical activity data, the respiration rate data, and the heart rate data of the patient from sensor 502, and the cough frequency data of the patient from sensor 508 are received by one or more processors 510.

At procedure 312, processor 410 (as shown in and explained with respect to FIG. 4) or 510 (as shown in and explained with respect to FIG. 5) is configured to generate a questionnaire to gather information from the patient. The questionnaire includes a set of questions that are based on one or more of the physical activity data, the respiration rate data, the heart rate data and the cough frequency data.

In one embodiment, the set of questions presented in the questionnaire are selected based on a decrease in the physical activity of the patient. In such an embodiment, the set of questions relate to physical activity levels of the patient.

In one embodiment, the set of questions presented in the questionnaire are selected based on an increase in the cough frequency of the patient. In such an embodiment, the set of questions relate to cough or sputum of the patient.

In one embodiment, the set of questions presented in the questionnaire are selected based an increase in the respiration rate of the patient with a decrease in the physical activity patient. In such an embodiment, the set of questions relate to dyspnea (i.e., shortness of breath or breathlessness) of the patient.

In one embodiment, the set of questions presented in the questionnaire are selected based on an increase in the heart rate of the patient with a decrease in the physical activity of the patient. In such an embodiment, the set of questions relate to psychological condition of the patient.

In one embodiment, the questionnaire may include one or more questions and responses to those questions. In one embodiment, the responses to the questions in the questionnaire provides the information of the patient. In one embodiment, a patient (or a healthcare personnel) may input (e.g., manually) the responses to those questions into the system 400 or 500 using an user interface 412 or 512 (as shown in and described with reference to FIGS. 4 and 5).

In one embodiment, the information may include information about respiratory symptoms of the patient, information about smoking history of the patient, information about psychological condition of the patient, information about specific physical activities performed by the patient, and information about any other illnesses of the patient. In one embodiment, the respiratory symptoms may include cough, phlegm, breathlessness, wheezing and chest illnesses.

Method 300 ends at procedure 314. In one embodiment, the procedures 302-314 can be performed by one or more computer program modules that can be executed by one or more processors 410 (as shown in and explained with respect to FIG. 4) or 510 (as shown in and explained with respect to FIG. 5).

System 400 for providing a questionnaire to a patient based on patient's current health condition in accordance with an embodiment of the present invention is shown in FIG. 4. In one embodiment, system 400 of the present invention may be used by patients in the home environment of the patient. In another embodiment, system 400 of the present invention may be used by a healthcare provider at a healthcare provider's location.

System 400 may include the activity monitor 402, the respiration rate sensor 404, the heart rate monitor 406, the cough frequency monitor 408, the processor 410, and the user interface 412. Activity monitor 402 is configured to detect body movements of the patient such that a signal from the activity monitor 402 is correlated to the level of a patient's physical activity. In one embodiment, the activity monitor 402 may include an accelerometer. In one embodiment, the accelerometer may be a three-axis accelerometer. Such an accelerometer may include a sensing element that is configured to determine acceleration data in at least three axes. For example, in one embodiment, the three-axis accelerometer may be a three-axis accelerometer (i.e., manufacturer part number: LIS3L02AQ) available from STMicroelectronics.

In one embodiment, the output of the accelerometer may be represented in arbitrary acceleration units (AAU) per minute. The AAU can be related to total energy expenditure (TEE), activity-related energy expenditure (AEE) and physical activity level (PAL). In another embodiment, the activity monitor 402 may be a piezoelectric sensor. The piezoelectric sensor may include a piezoelectric element that is sensitive to body movements of the patients.

In one embodiment, activity monitor 402 may be positioned, for example, at the thorax of the patient or at the abdomen of the patient. In one embodiment, the activity monitor 402 may be a part of a wearable band (that may be worn on the wrist, waist, arm or any other portion of the patient's body for example) or may be part of wearable garment worn by the patient. In one embodiment, activity monitor 402 may be directly connected to the processor 410. In such an embodiment, the activity monitor may be connected to processor 410 over a wired or wireless network, for example.

In one embodiment, the respiration rate sensor 404, which is configured to measure the respiration pattern of the patient, may include an accelerometer or a microphone. In one embodiment, the accelerometer may be a three-axis accelerometer. For example, in one embodiment, the three-axis accelerometer may be a three-axis accelerometer available from STMicroelectronics.

In one embodiment, a microphone is constructed and arranged to receive sound of inspiration of the patient in order to determine the respiration rate of the patient. In one embodiment, the respiration rate sensor 404 may be a Respiband™ available from Ambulatory Monitoring, Inc. of Ardsley, N.Y. In one embodiment, Respiband™ measures the respiration rate using inductance.

In one embodiment, respiration rate sensor 404 may include a chest band and a microphone as described in U.S. Pat. No. 6,159,147, hereby incorporated by reference. In such an embodiment, the chest band may be placed around a patient's chest to measure the patient's respiration rate, for example. Sensors on the chest band may measure movement of the patient's chest. Data from sensors on the chest band is input into a strain gauge and subsequently amplified by an amplifier.

In one embodiment, respiration rate sensor 404 may be directly connected to the processor 410. In such an embodiment, the respiration rate sensor may be connected to the processor over a wired or wireless network, for example.

In one embodiment, the heart rate monitor 406 is configured to monitor the heart beat of the patient such that a signal from the heart rate monitor 406 is correlated to the patient's heart rate. In one embodiment, the heart rate monitor 406 is electronic and electronically inputs the heart rate data into the processor 410. Heart rate monitor 406 may include a wearable heart rate monitor (e.g., Polar F7 heart rate monitor watch) available from Polar. In one embodiment, the heart rate monitor may include a built in microprocessor that analyzes an EKG signal to determine the heart rate of the patient. In one embodiment, the heart rate monitor may include a transmitter located at the position where the patient's heart is located so as to detect the patient's heartbeat and a receiver located, for example, on patient's wrist.

In one embodiment, heart rate monitor 406 is configured to analyze an electrocardiography signal of patient to determine the patient's heart rate. In one embodiment, the heart rate monitor may be directly connected to the processor 410. In such an embodiment, the heart rate monitor may be connected to the processor over a wired or wireless network, for example.

In one embodiment, cough frequency monitor 408 is configured to monitor the number of coughs of the patient per unit of time such that a signal from the cough frequency monitor is correlated to the patient's cough frequency. The cough frequency is generally representative of number of coughs of the patient per unit of time. In one embodiment, the cough frequency is expressed as cough counts per hour.

In one embodiment, cough frequency monitor 408 may include a recording device for recording cough via a microphone located, for example, on the chest wall of the patient, or over the trachea of the patient. In such an embodiment, the signals from the recording device are analyzed to determine the cough frequency of the patient. In another embodiment, cough frequency monitor 408 may include an accelerometer that is placed at the supra-notch. In such an embodiment, the signals from the accelerometer are recorded and are analyzed to determine the cough frequency of the patient.

In one embodiment, cough frequency monitor 408 may in the form of a wearable monitor (e.g., Lifeshirt® system) available from Vivometrics. In such a monitor, cough is detected using a combination of sound (from a unidirectional throat microphone) and respiratory inductance plethysmography (RIP). Also, such a monitor may include a accelerometer to measure respiratory parameters, electrocardiograph, and activity of the patient. Cough frequency monitor 408 may be directly connected to processor 410. In such an embodiment, the cough frequency monitor may be connected to the processor over a wired or wireless network, for example.

In one embodiment, processor 410 is configured to receive the physical activity data of the patient from activity monitor 402, the respiration rate data of the patient from respiration rate sensor 404, the heart rate data of the patient from heart rate monitor 406, and the cough frequency data of the patient from cough frequency monitor 408.

In one embodiment, processor 410 is configured to retrieve questions from a data storage unit or memory based on the current health condition of the patient and to display the questions and the respective reply choices (i.e., in the form of a questionnaire) to the patient on user interface 412. In other words, the processor is configured to generate a questionnaire having a set of questions (that are retrieved from the data storage unit or memory) that are based on one or more of the physical activity data, the respiration rate data, the heart rate data and the cough frequency data.

In one embodiment, the data storage unit or memory of system 400 may be configured to store a plurality of questions. In one embodiment, the data storage unit or memory is a standalone device. However, it is contemplated that the data storage unit or memory may be part of processor 410. In one embodiment, these plurality of questions stored in the data storage unit may be further classified into groups, where each group of questions focuses on gathering information about a certain aspect/symptom of the disease. For example, these groups may be configured to gather information about respiratory symptoms of the patient, information about smoking history of the patient, information about psychological condition of the patient, information about specific physical activities performed by the patient, and information about any other illnesses of the patient. In one embodiment, the respiratory symptoms may include cough, phlegm, breathlessness, wheezing and chest illnesses.

In one embodiment, the questions of the questionnaire may have responses that are scaled (i.e., the response is graded (e.g., severity of breathlessness of a patient on a scale of 1 to 5, with 5 being the most breathless)). In another embodiment, the questions of the questionnaire may have multiple responses/answers, where a response may be chosen from multiple options presented. In another embodiment, the questions of the questionnaire may have “yes/no” (or true/false) responses, where the response may be chosen between a “yes” and a “no.”

FIG. 7 shows an exemplary algorithm that is used by the processor 410 to select a set of relevant questions. These set of relevant questions are then presented in the form of a questionnaire to the patient for completion. In one embodiment, the algorithm is saved in processor 410 or in the data storage unit of the system 400.

In one embodiment, as shown in the exemplary algorithm of FIG. 7, the set of questions presented in the questionnaire are selected based on a decrease in the physical activity of the patient. If processor 410 detects a decrease in the physical activity of the patient, then the processor is configured to generate a questionnaire that includes a set of questions related to the physical activity levels of the patient.

In one embodiment, as shown in the exemplary algorithm of FIG. 7, the set of questions presented in the questionnaire are selected based on an increase in the cough frequency of the patient. If the processor detects an increase in the cough frequency of the patient, then the processor is configured to generate a questionnaire that includes a set of questions related to the cough and sputum of the patient.

In one embodiment, as shown in the exemplary algorithm of FIG. 7, the set of questions presented in the questionnaire are selected based on an increase in the respiration rate of the patient with a decrease in the physical activity of the patient. If there is an increase in respiration rate of the patient while the patient is relatively inactive, then it may suggest that the patient is suffering from dyspnea (i.e., shortness of breath or breathlessness). If processor 410 detects an increase in the respiration rate with a constant activity level or a decrease in activity level (i.e., the patient is having problems with dyspnea), then the processor is configured to generate a questionnaire that includes a set of questions related to dyspnea.

In one embodiment, as shown in the exemplary algorithm of FIG. 7, the set of questions presented in the questionnaire are selected based on an increase in the heart rate of the patient with a decrease in the physical activity of the patient. If the heart rate of the patient is higher than normal while the patient is relatively inactive, then it may suggest that the patient is suffering from anxiety. If processor 410 detects an increase in the heart rate with a constant activity level or a decrease in activity level (i.e., the patient is having anxiety), then the processor is configured to generate a questionnaire that includes a set of questions related to psychological status of the patient. In another embodiment, questions in the questionnaire may also be selected based on the response(s) (i.e., received from the patient) to the previous question(s). In one embodiment, the responses are received from the patient in prior days.

System 400 may include a user interface 412, which is in communication with processor 410. User interface 412 is configured to accept input from the patient (or caregiver), and optionally to transmit (and display) output of the system. In one embodiment, the user interface may include a keyboard, keypad or touchscreen that allows the patient or caregiver to input the responses (i.e., clinical information of the patient) to the questions in the questionnaire. User interface 412 may include a display screen that provides a visual data output (e.g., displays questionnaire with questions and their responses) to the patient. In one embodiment, the user interface may be a graphical user interface. It may also include a printer or be connected to a printer so as to be able to print information from processor 410. User interface 412 may be provided integral with the processor. In another embodiment, the user interface 210 may be provided remote from or proximal to processor 410.

In one embodiment, system 400 may include a questionnaire system that is configured to perform the function of gathering the responses to the questions presented in the questionnaire. In one embodiment, the questionnaire system may include a data storage unit or memory that may be configured to store the responses received in response to those questions. In one embodiment, the questionnaire system is a standalone device. However, it is contemplated that the questionnaire system may be part of the processor.

In one embodiment, the patient (or care provider) may manually input responses (i.e., the information of the patient) to the questions in the questionnaire into the questionnaire system using user interface 412 (as shown in and described with reference to FIG. 4). In one embodiment, the questionnaire system is configured to send the stored responses (i.e., clinical information of the patient) to one or more processors 410 for further processing, for example, for trending, and/or display. In such an embodiment, the questionnaire system (along with the data storage unit or memory of the questionnaire system) may be in communication with the user interface 412 to display the stored data or the trend charts.

In system 400 shown in FIG. 4, separate sensors are used to measure the physical activity of the patient, the respiration rate of the patient, and the heart rate of the patient. However, it is contemplated, that a single sensor may be used to measure the physical activity of the patient, the respiration rate of the patient, and the heart rate of the patient as explained below.

FIG. 5 shows a system 500 for providing a questionnaire to a patient based on patient's current health condition in accordance with another embodiment of the present invention. System 500 is configured to generate a questionnaire that includes a set of questions that are based on one or more of the physical activity data, the respiration rate data, the heart rate data and the cough frequency data. System 500 includes a sensor 502, a cough frequency monitor 508, a processor 510, and a user interface 512. In one embodiment, the objective assessment of the physical activity, the respiration rate, and the heart rate of the patient is done using a sensor, for example, an accelerometer (i.e., instead of activity monitor 402, respiration rate sensor 404, and heart rate monitor 406 as described above with respect to FIG. 4).

In one embodiment, sensor 502 may be an accelerometer. In one embodiment, the accelerometer may be a three-axis accelerometer. Such an accelerometer may include a sensing element that is configured to determine acceleration data in at least three axes. For example, in one embodiment, the three-axis accelerometer may be a three-axis accelerometer (i.e., manufacturer part number: LIS3L02AQ) available from STMicroelectronics.

In one embodiment, sensor 502 may be positioned, for example, at the thorax of the patient or at the abdomen of the patient. In one embodiment, as shown in FIG. 6, the accelerometer is positioned at the lower ribs, roughly halfway between the central and lateral position. The positioning of the accelerometer shown in FIG. 6 allows monitoring of both the respiration rate, the heart rate and the physical activity of the patient. In another embodiment, the sensor 502 may be positioned such that the sensor 502 is in close proximity with at least a portion of the patient's body.

In one embodiment, the sensor 502 may be a part of a wearable band (that can be worn on the wrist, waist, arm or any other portion of the patient's body for example) or may be part of wearable garment worn by the patient.

In one embodiment, the processor 510 of the system 500 can comprise either one or a plurality of processors therein. Thus, the term “processor” as used herein broadly refers to a single processor or multiple processors. In one embodiment, processor 510 can be a part of or forming a computer system. The processor is configured to a) continuously receive acceleration data from sensor 502 in at least the axes; b) determine the respiration rate data and the heart rate data from the accelerometer data received from the sensor 502; c) determine physical activity data associated with the respiration rate data and the heart rate data; d) determine cough frequency data from the sensor 508; and e) to generate a questionnaire that includes a set of questions that are based on one or more of the physical activity data (received from the sensor 502), the respiration rate data (received from the sensor 502), the heart rate data (received from the sensor 502), and the cough frequency data (received from the sensor 508).

In one embodiment, the respiration rate may be determined intermittently over period of time (i.e., the course of day). In one embodiment, the respiration rate is measured during rest and predetermined activity level (e.g., moderate walk for more than 2 minutes).

In one embodiment, a segmentation algorithm may be used to determine the respiration rate from the accelerometer data. The segmentation algorithm is configured to select the periods during which the respiration rate may be determined. The segmentation of the data may be desirable necessary because it may not always be possible to determine the respiration rate reliably during the physical activity using an accelerometer (and/or other sensors). In one embodiment, the segmentation algorithm serves to automatically identify the periods of time during which the respiration rate can be determined reliably. In one embodiment, because the respiration rate doesn't immediately return to baseline values after an activity this is not a problem for the method.

In one embodiment, the respiration rate data measured for a predetermined length of time (e.g., about 20-30 seconds) is sufficient to determine the respiration rate reliably.

In one embodiment, the physical activity associated with this respiration rate value may then be the averaged over the last 5 minutes or 15 minute period rather than just that 20-30 seconds during which the respiration rate was calculated. In one embodiment, the physical activity in a 15-minute period preceding the time instances at which the respiration rate have been determined reliably.

Cough frequency monitor 508, processor 510, and user interface 512 of system 500 are similar to cough frequency monitor 408, processor 410, and user interface 412 of system 400 (shown and described in detail with respect to FIG. 4), and hence will not be explained in detail here.

Besides generating a questionnaire that includes a set of questions that are based on the patient's current health status (i.e., one or more of the physical activity data, the respiration rate data, the heart rate data and the cough frequency data), method 300 and systems 400 and 500 may be used in other circumstances where the simultaneous assessment of the physical activity, the respiration rate, and heart rate may predict the onset of an exacerbation of a COPD patient; where the simultaneous assessment of the physical activity, and the respiration rate may predict the onset of an exacerbation of a COPD patient and/or assess the level of dyspnea in the patient.

In one embodiment, the systems 400 and 500 may each include a single processor that may be configured to process the respiration rate data, the physical activity data, the heart rate data and the cough frequency of the patient to generate a questionnaire that includes a set of questions that are based on one or more of the physical activity data, the respiration rate data, the heart rate data and the cough frequency data.

In another embodiment, systems 400 and 500 may each include multiple processors, where each processor is configured to perform a specific function or operation. In such an embodiment, the multiple processors may be configured to process the respiration rate data, the physical activity data, the heart rate data and the cough frequency of the patient to generate a questionnaire that includes a set of questions that are based on one or more of the physical activity data, the respiration rate data, the heart rate data and the cough frequency data.

In one embodiment, method 300 and systems 400 and 500 may be used in a rehabilitation center (e.g., for COPD patients, or heart failure patients). In one embodiment, method 300 and the systems 400 and 500 may also be applied for home rehabilitation to enable patient assessment and intervention to be provided remotely. Method 300 (and the systems 400 and 500 described above) is configured to incorporate the advantages of both the short questionnaire and the long questionnaire, while eliminating the inherent disadvantages of these questionnaires.

Embodiments of the invention, the processor, for example, may be made in hardware, firmware, software, or various combinations thereof. The invention may also be implemented as instructions stored on a machine-readable medium, which may be read and executed using one or more processors. In one embodiment, the machine-readable medium may include various mechanisms for storing and/or transmitting information in a form that may be read by a machine (e.g., a computing device). For example, a machine-readable storage medium may include read only memory, random access memory, magnetic disk storage media, optical storage media, flash memory devices, and other media for storing information, and a machine-readable transmission media may include forms of propagated signals, including carrier waves, infrared signals, digital signals, and other media for transmitting information. While firmware, software, routines, or instructions may be described in the above disclosure in terms of specific exemplary aspects and embodiments performing certain actions, it will be apparent that such descriptions are merely for the sake of convenience and that such actions in fact result from computing devices, processing devices, processors, controllers, or other devices or machines executing the firmware, software, routines, or instructions.

Although the invention has been described in detail for the purpose of illustration, it is to be understood that such detail is solely for that purpose and that the invention is not limited to the disclosed embodiments, but, on the contrary, is intended to cover modifications and equivalent arrangements that are within the spirit and scope of the appended claims. In addition, it is to be understood that the present invention contemplates that, to the extent possible, one or more features of any embodiment may be combined with one or more features of any other embodiment.

1. A computer-implemented method for providing a questionnaire to a patient based on patient's current health condition, wherein the method is implemented in a computer system comprising one or more processors configured to execute one or more computer programs modules, the method comprising:
measuring physical activity of a patient with an activity monitor to gather physical activity data;
measuring respiration rate of such a patient with a respiration rate sensor to gather respiration rate data;
measuring heart rate of such a patient with a heart rate monitor to gather heart rate data;
measuring cough frequency of such a patient with a cough frequency monitor to gather cough frequency data; and
executing, on a processor of a computer system, one or more computer program modules configured to generate a questionnaire to gather information from such a patient, wherein generating the questionnaire comprises selection of a set of questions from a plurality of sets of questions, with selections being based on one or more of the physical activity data, the respiration rate data, the heart rate data or the cough frequency data.

2. The method of claim 1, wherein the set of questions are selected based on
(a) a decrease in the physical activity of the patient,
(b) an increase in the cough frequency of the patient,
(c) an increase in the respiration rate of the patient with a decrease in the physical activity of the patient; or
(d) an increase in the heart rate of the patient with a decrease in the physical activity of the patient.

3. (canceled)

4. The method of claim 1, wherein the respiration rate sensor or the cough frequency monitor is a microphone.

5. The method of claim 1, wherein the respiration rate sensor is configured to measure the respiration rate of patient using inductance.

6. The method of claim 1, wherein the cough rate monitor is configured to measure the respiration rate of patient using inductance and sound.

7. The method of claim 1, wherein the heart rate monitor is configured to analyze an electrocardiography signal of patient to determine the heart rate.

8. The method of claim 1, wherein the information gathered from such a patient includes information pertaining to:
respiratory symptoms of such a patient,
smoking history of such a patient,
psychological condition of such a patient,
specific physical activities performed by such a patient, and
other illnesses of such a patient.

9. (canceled)

10. A system for providing a questionnaire to a patient based on such a patient's current health condition, the system comprising:
a sensor configured to measure:
a) physical activity of the patient to gather physical activity data,
b) a respiration rate of the patient to gather respiration rate data,
c) heart rate of the patient to gather heart rate data, and
d) cough frequency of the patient to gather cough frequency data; and
a processor operatively connected to the sensor and configured to generate a questionnaire to gather information from such a patient, wherein generating the questionnaire comprises selection of a set of questions from a plurality of sets of questions, with selections being based on one or more of the physical activity data, the respiration rate data, the heart rate data or the cough frequency data.

11. The system of claim 10, wherein the set of questions are selected based on:
(a) a decrease in the physical activity of such a patient,
(b) an increase in the cough frequency of such a patient,
(c) an increase in the respiration rate of the patient with a decrease in the physical activity of such a patient, or
(d) an increase in the heart rate of the patient with a decrease in the physical activity of such a patient.

12. The system of claim 10, wherein the sensor includes an activity monitor, a respiration rate sensor, a heart rate monitor, and a cough frequency monitor.

13. (canceled)

14. The system of claim 12, wherein the respiration rate sensor, cough frequency monitor, or both is a microphone.

15. The system of claim 12, wherein the respiration rate sensor is configured to measure the respiration rate of patient using inductance.

16. The system of claim 10, wherein the information gathered from such a patient includes information pertaining to:
respiratory symptoms of such a patient,
smoking history of such a patient,
psychological condition of such a patient,
specific physical activities performed by such a patient, and
other illnesses of such a patient.

17. Cancelled

18. A system for providing a questionnaire to a patient based on such a patient's current health condition, the system comprising:
means for measuring physical activity of such a patient to gather physical activity data;
means for measuring respiration rate of such a patient to gather respiration rate data;
means for measuring heart rate of such a patient to gather heart rate data;
means for measuring cough frequency of such a patient to gather cough frequency data; and
means for executing a computer program module to generate a questionnaire to gather information from such a patient, wherein generating the questionnaire comprises selection of a set of questions from a plurality of sets of questions, with selections being based on the physical activity data, the respiration rate data, the heart rate data, the cough frequency data, or any combination thereof.

19. The system of claim 14, wherein the set of questions are selected based on:
a decrease in the physical activity of the patient
an increase in the cough frequency of the patient
an increase in the respiration rate of the patient with a decrease in the physical activity of the patient
an increase in the heart rate of the patient with a decrease in the physical activity of the patient.
